(19) United States
(12) Patent Application Publication
(10) Pub. No.: US 2026/0040065 A1
(43) Pub. Date: Feb. 5, 2026

(54) KEYS FROM WIRELESS CHANNEL IN CELLULAR SYSTEM

(71) Applicant: Apple Inc., Cupertino, CA (US)

(72) Inventors: Chunxuan Ye, San Diego, CA (US); Wei Zeng, Saratoga, CA (US); Huarui Liang, Beijing (CN); Haijing Hu, Los Gatos, CA (US); Shu Guo, Beijing (CN); Dawei Zhang, Saratoga, CA (US); Haitong Sun, Saratoga, CA (US)

(73) Assignee: Apple Inc., Cupertino, CA (US)

(21) Appl. No.: 19/258,653

(22) Filed: Jul. 2, 2025

Related U.S. Application Data
(60) Provisional application No. 63/678,958, filed on Aug. 2, 2024.

(51) Int. Cl. H04W 12/041

(52) U.S. Cl. CPC H04W 12/041

(57) ABSTRACT

The present application relates to devices and components including apparatus, systems, and methods for configuring elements of a network for generating a physical layer key.

### CROSS-REFERENCE TO RELATED APPLICATION

This application claims priority to U.S. provisional application No. 63/678,958, entitled “Keys from Wireless Channel in Cellular System,” filed on Aug. 2, 2024, the disclosure of which is incorporated by reference herein in its entirety for all purposes.

### TECHNICAL FIELD

The present application relates to the field of wireless technologies and, in particular, to generation of keys, including secret keys, in a cellular system.

### BACKGROUND

Third Generation Partnership Project (3GPP) networks utilizes keys for authentication and determining authorization for communications among devices of the networks. In particular, keys are generated for user equipments (UEs) that are used for determining whether the UEs are allowed to access the network and/or which portions of the network the UEs are allowed to access. The networks attempt to protect these keys against unauthorized obtainment and use by unauthorized users.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates an example key hierarchy generation arrangement in accordance with some embodiments.

FIG. 5 illustrates an example access stratum (AS) security mode command procedure in accordance with some embodiments.

FIG. 6 illustrates an example procedure of generating physical layer secret keys in cellular system in accordance with some embodiments.

FIG. 7 illustrates example reference signal arrangements in accordance with some embodiments.

FIG. 8 illustrates additional example reference signal arrangements in accordance with some embodiments.

FIG. 9 illustrates an example procedure for configuring physical layer key generation in accordance with some embodiments.

FIG. 10 illustrates an example procedure for synchronizing for generating a physical layer key in accordance with some embodiments.

FIG. 11 illustrates an example procedure for generating a physical layer key in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

With the view of increasing of security in wireless networks, a physical layer secret key may be utilized for security purposes, including authentication of user devices and/or determining authorization of the user devices to access the network or portions thereof.

A user equipment (UE) may connect to a base station within a wireless network. As part of the connection process (or after the UE and the base station have established a connection), a secret key may be generated for the UE. The UE and the base station may each independently generate the secret key. The secret key may be derived from a value that changes with time. For the UE and the base station to generate matching copies of the secret key, the UE and the base station need to generate the secret key at a same time or within a threshold time of each other. The UE and the base station may need to be synchronized to verify that both the UE and the base station generate the secret key at the same time or within the threshold time of each other. Approaches described herein can configure the UE and the base station for synchronization to verify that each of the UE and the base station generate the secret key at the same time or within the threshold time.

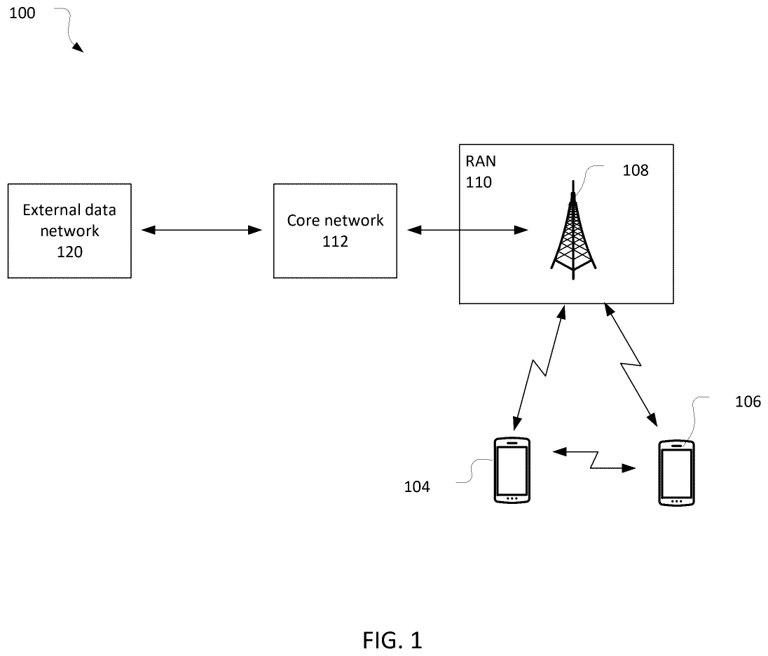

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

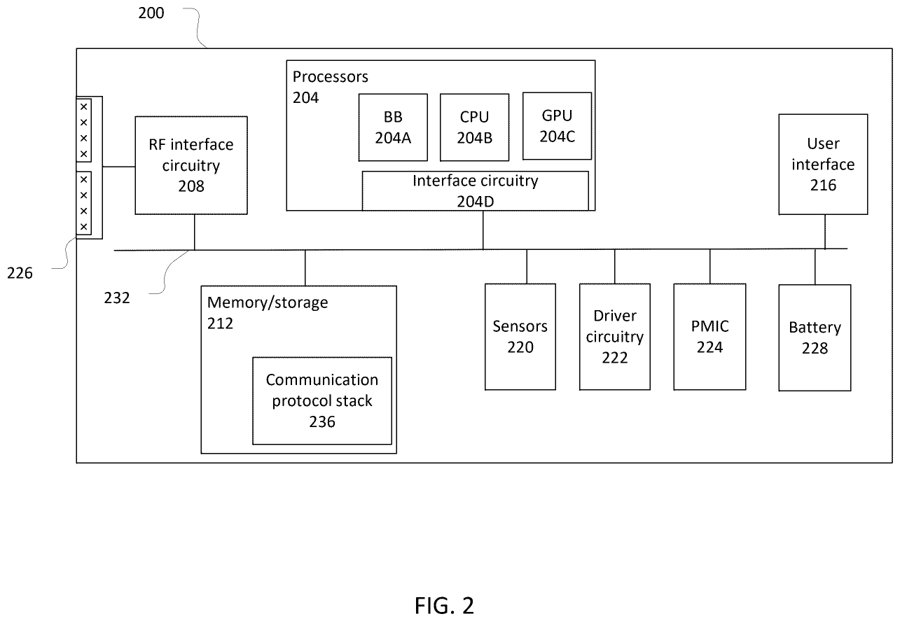

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

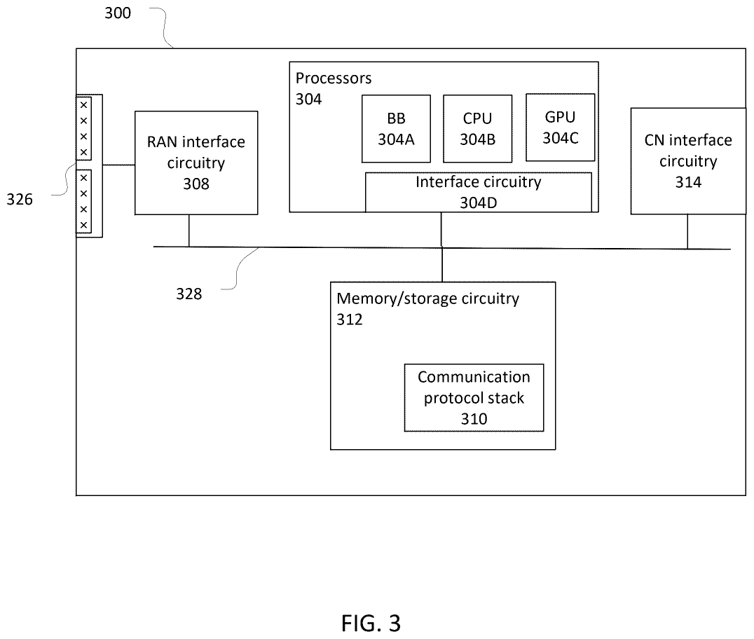

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

A fifth generation system (5GS) implements key hierarchy generation. The keys related to authentication include K and cipher key/integrity key (CK/IK). In case of extensible authentication protocol (EAP)-authentication and key management (AKA)′, the keys CK′, IK′ are derived from CK, IK.

The key hierarchy includes a key for “Authentication Server Function” (K_{AUSF}) in home network, that is derived by CK′ and IK.′ The key hierarchy further includes a K_{SEAF}: Anchor key “SEcurity Anchor Function,” which is derived by K_{AUSF}. The key hierarchy further includes a key for access and mobility management function (AMF) (K_{A}MF) in serving network, which is derived by K_{SEAF}. The key hierarchy may further include keys for NAS signaling, including K_{NASint} and K_{NASene}. The key hierarchy may further include a key for NG-RAN (K_{gNB}), which is derived from keys for radio resource control (RRC)/User Plan traffic for encryption or integrity, including K_{RRCint}, K_{RRCenc}, K_{UPint} and K_{UPene}. The K_{RRCint}, K_{RRCenc}, K_{UPint} and K_{UPene} may be derived from K_{gNB}.

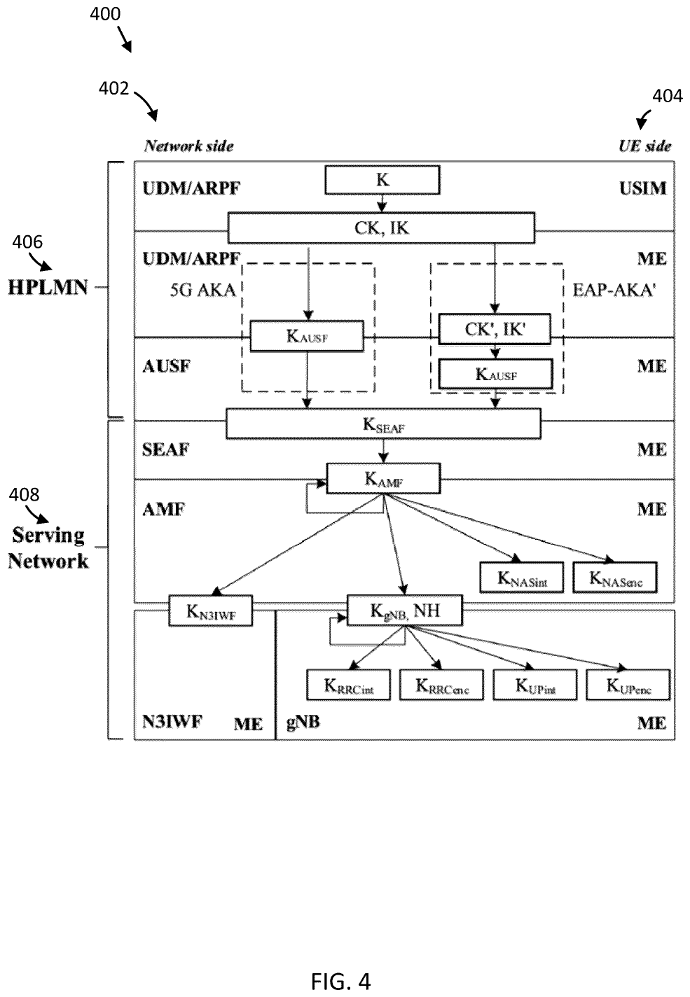

FIG. 4 illustrates an example key hierarchy generation arrangement 400 in accordance with some embodiments. The arrangement 400 illustrates keys that are generated within a network in legacy approaches.

The arrangement 400 includes a network side 402 (which corresponds to a base station and/or a core network) and a user equipment (UE) side 404 (which corresponds to a UE). The arrangement 400 further includes a home public land mobile network (HPLMN) portion 406 and a serving network portion 408. Keys illustrated in the arrangement 400 in the HPLMN portion 406 may be keys utilized between the UE and an HPLMN serving the UE. Keys illustrated in the arrangement 400 in the serving network portion 408 may be keys utilized between the UE and a serving network serving the UE.

The arrangement 400 includes a key (K). A CK and an IK is derived from the K. A K_{AU}SF is derived from the CK and the IK. Further, a K_{SEAF} is derived from the K_{AU}SF. A K_{AMF} is derived from the K_{AMF}. A K_{N3IWF}, a K_{gNB}, NH, a K_{NASint}, and a K_{NASene} are derived from the K_{AMF}. A K_{RRCint}, a K_{RRCenc}, a K_{UPint}, and a K_{UPene} are derived from the K_{g}NB, NH.

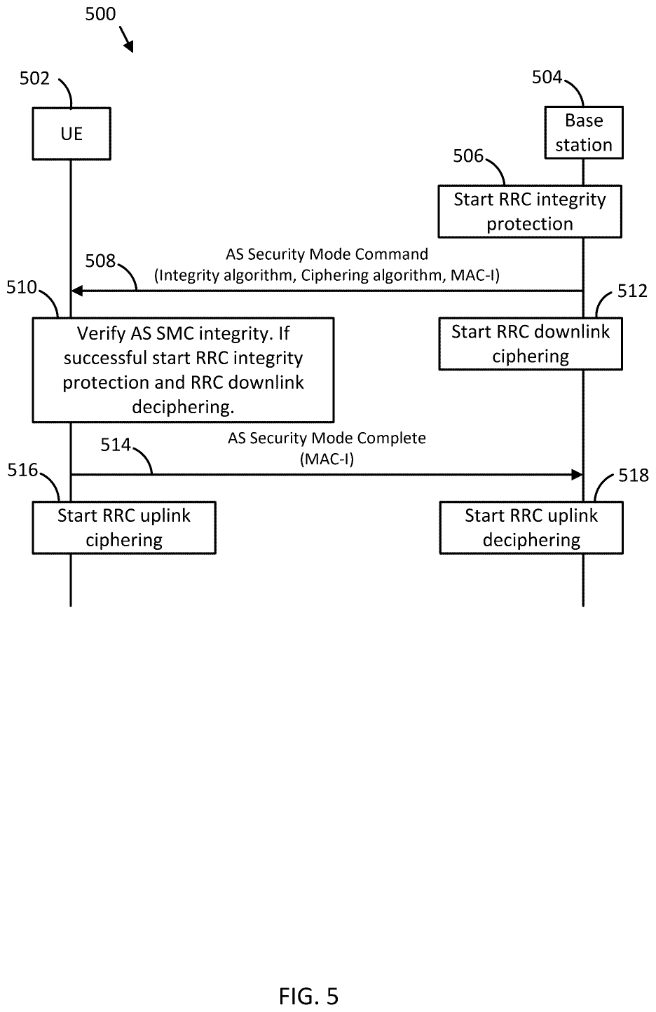

Legacy NAS layer security negotiation is illustrated in FIG. 5. In preparation for the legacy NAS layer security negotiation, the UE provides UE security capabilities in a “Registration Request” message to an AMF, so the AMF has knowledge of the UE's security capabilities.

The UE transmits to radio access network (RAN) or access network (AN), which in turn transmits to the AMF an access network (AN) message (that includes AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters], [extended idle mode DRX parameters], [LADN DNN(s) or Indicator Of Requesting LADN Information], [NAS message container], [Support for restriction of use of Enhanced Coverage], [Preferred Network Behavior], [UE Policy Container (the list of PSIs, indication of UE support for ANDSP and the operating system identifier)] and [UE Radio Capability ID], PEI)).

FIG. 5 illustrates an example access stratum (AS) security mode command procedure 500 in accordance with some embodiments. In particular, FIG. 5 illustrates example security architecture and procedures for a fifth generation (5G) system.

The procedure 500 may include a UE 502. The UE 502 may include one or more of the features of the UE 104 (FIG. 1), the UE 106 (FIG. 1), and/or the UE 200 (FIG. 2). The procedure 500 may further include a base station 504. The base station 504 may include one or more of the features of the base station 108 (FIG. 1), and/or the network device 300 (FIG. 3).

The procedure 500 may include an AMF activating the NAS integrity protection in 506 before sending the NAS security mode command message. For example, the base station 504 may start a radio resource control (RRC) integrity protection operation.

The procedure 500 may include an access stratum (AS) security mode command message 508 being sent from the base station 504 to the UE 502. The AS security mode command message 508 may contain the selected RRC and user plane (UP) encryption and integrity algorithms. This AS security mode command message 508 may be integrity protected with RRC integrity key based on a legacy base station key (K_{gNB}).

The procedure 500 may include the base station 504 activating the RAN downlink ciphering in 512 after sending the AS security mode command message 508. For example, the base station 504 may start RRC downlink ciphering in 512.

The procedure 500 may include the UE 502 verifying the integrity protection of the AS security mode command message 508 using the legacy K_{gNB} in 510. For example, the UE 502 may verify AS security mode command (SMC) integrity in 510. If the verification is successful, the UE 502 may start RRC integrity protection and RRC downlink deciphering.

The procedure 500 may include an AS security mode complete message 514 being transmitted from the UE 502 to the base station 504. The AS security mode complete message 514 may be integrity protected with the selected RRC algorithm indicated in the AS security mode command message 508 and an RRC integrity key based on the legacy K_{gNB}.

The procedure 500 may include the UE 502 starting RRC uplink ciphering in 516. Further, the procedure 500 may include the base station 504 starting RRC uplink deciphering in 518.

An issue to be addressed for physical layer secret key generation may be what is the procedure of generating physical layer secret key? In particular, a configuration of the physical layer secret key may be defined. The configuration of the physical layer secret key may include configuration of downlink and uplink reference signal, and/or configuration of physical layer key generation. The configuration of physical layer key generation may include error correction codes information, assistance information for physical layer key generation, universal hashing function for key generation information, and/or key verification information.

Further to be addressed may be the contents and the container for synchronization for physical layer key generation. Additionally, contents and container for assistant information for physical layer key generation may need to be addressed. Further, the contents and container for alignment of physical layer key may yet to be addressed.

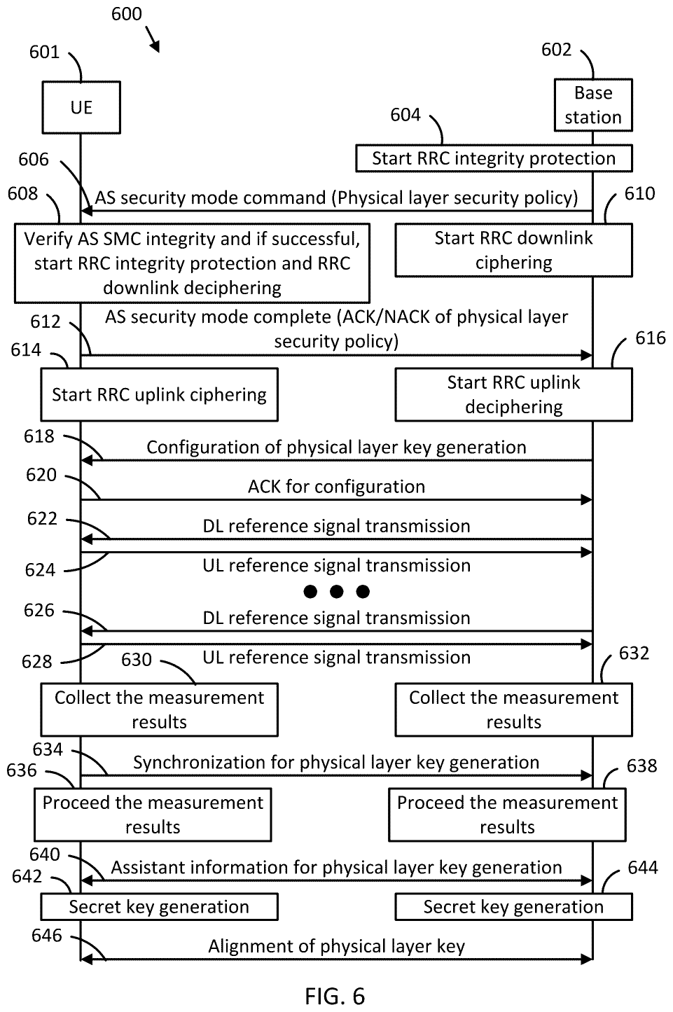

FIG. 6 illustrates an example procedure 600 of generating physical layer secret keys in cellular system in accordance with some embodiments. For example, the procedure 600 may include general procedures of generating physical layer secret keys in a cellular system.

The procedure 600 includes a UE 601. The UE 601 may include one or more of the features of the UE 104 (FIG. 1), the UE 106 (FIG. 1), and/or the UE 200 (FIG. 2). The procedure 600 further includes a base station 602. The base station 602 may include one or more of the features of the base station 108 (FIG. 1), and/or the network device 300 (FIG. 3).

If “AS security mode complete” contains “ACK/NCK of physical layer security policy,” then the UE 601 and the base station 602 may start to generate physical layer key. For example, the base station 602 may start a radio resource control (RRC) integrity protection operation in 604. The base station 602 may generate and/or transmit an AS security mode command message 606 to the UE 601. The AS security mode command message 606 may include a physical layer security policy.

In 608, the UE 601 may verify AS SMC integrity and, if successful, start RRC integrity protection and RRC downlink deciphering. In 610, the base station 602 may start RRC downlink ciphering.

The UE 601 may generate and/or transmit an AS security mode complete message 612 to the base station 602. The AS security mode complete message 612 may include an acknowledge (ACK) or a negative acknowledge (NACK) of the physical layer security policy.

In 614, the UE 601 may start RRC ciphering. In 616, the base station 602 may start RRC uplink deciphering.

The procedure 600 may include the base station 602 sending configuration of physical layer key generation message 618 to the UE 601. The contents of the configuration may include configuration of downlink reference signal, configuration of uplink reference signal, and/or configuration of physical layer key generation. A container of the configuration may be a dedicated RRC message.

The procedure 600 may include the UE 601 sending the ACK of the configuration message 620 to the base station 602. It is possible that the UE 601 may send the modified configuration with base station 602 (e.g., the periodicity of downlink (DL)/uplink (UL) reference signals).

The procedure 600 may include one or more DL/UL reference signal transmissions. For example, the procedure 600 includes a first DL reference signal transmission 622, a first UL reference signal transmission 624, a second DL reference signal transmission 626, and a second UL reference signal transmission 628 in the illustrated embodiments. The DL/UL reference signal transmissions may be paired transmissions, where one DL reference signal transmission has the corresponding UL reference signal transmission. It is possible that a DL reference signal is transmitted before or after a UL reference signal, depending on the configuration of DL/UL reference signal. It is possible DL/UL reference signals are periodic, with or without ON/OFF duration.

In 630, the UE 601 may collect measurement results. In 632, the base station 602 may collect measurement results.

The procedure 600 may include synchronization for physical layer key generation. A synchronization for physical layer key generation message 634 can be both from UE to base station and from base station to UE. For example, the synchronization for physical layer key generation message 634 is transmitted from the UE 601 to the base station 602 in the illustrated embodiment. This message may be triggered when a certain number of DL/UL reference signal transmissions depending on configuration.

Contents of the synchronization for physical layer key generation message 634 may include a bitmap of length being the number of DL (or UL) reference signal transmissions from the previous synchronization message or from the beginning of the DL reference signal transmissions. The bitmap may include a bit of ‘0’ that indicates the corresponding DL (or UL) reference signal measurement is successful or reliable, or a bit of ‘1’ that indicates the corresponding DL (or UL) reference signal measurement is unsuccessful or not reliable. In a first alternative, a container for the physical layer key generation message 634 may include a medium access control (MAC) control element (CE). The length of the MAC CE may be limited. In a second alternative, a container for the physical layer key generation message 634 may include a dedicated RRC message.

In 636, the UE 601 may proceed with the measurement results. In 638, the base station 602 may proceed with the measurement results.

The procedure 600 may include assistant information for physical layer key generation. An assistant information for physical layer key generation message 640 can be either from UE 601 to base station 602 or from base station 602 to UE 601, depending on configuration. Contents of the assistant information for physical layer key generation message 640 may include cyclic redundancy check (CRC) bits of polar codes or syndrome bits of low-density parity-check (LDPC) codes, and/or quantization error bits. A container for the assistant information for physical layer key generation message 640 may MAC CE in a first alternative or a dedicated RRC message in a second alternative.

In 642, the UE 601 may proceed with secret key generation. In 644, the base station 602 may proceed with secret key generation.

The procedure 600 may include alignment of physical layer key. An alignment of physical layer key message 646 can be from the UE 601 to the base station 602 in some instances, and base station 602 may send acknowledge (ACK) or negative acknowledge (NACK) for the alignment results. In other instances, it can be from the base station 602 to UE 601, and the UE 601 may send ACK or NACK for the alignment results. The contents of the alignment of physical layer key message 646 may include a bit sequence which is derived from the physical layer key. The container of the alignment of physical layer key message 646 may be a MAC CE in a first alternative or a dedicated RRC message in a second alternative.

Approaches herein may include one or more of the following features for the configuration of the physical layer key generation. For example, the following features may be included in a configuration of the configuration of physical layer key generation message 618. The base station may send configuration of physical layer key generation to the UE.

The configuration of physical layer key generation may include configuration of downlink reference signal. The configuration of downlink reference signal may include a type of downlink reference signal to be utilized for synchronization. In a first alternative, the type of downlink reference signal may be channel state information-reference signal (CSI-RS) (e.g., periodical CSI-RS, semi-persistent CSI-RS). In a second alternative, the type of downlink reference signal may be a new reference signal for measurements. In a third alternative, the type of downlink reference signal may be a synchronization signal block (SSB). For these reference signals, channel state information (CSI) feedback may not be necessary.

The configuration of physical layer key generation may include downlink reference signal time domain resources to be utilized for synchronization.

In a first alternative (which may be referred to as “Alt A-1”), the downlink reference signal time domain resources may include periodic downlink (DL) reference signals. The periodicity of the periodic DL reference signals may depend on wireless channel condition, such as the periodicity may be larger than the channel coherence time and/or the periodicity may depend on the base station's estimation of channel coherence time or may depend on the UE's report on channel coherence time. The indication of the periodic DL reference signals may include slots with the DL reference signal (e.g., periodicity and offset), symbols with the DL reference signal, and/or a starting time of the periodic DL reference signal.

In a second alternative (which may be referred to as “Alt A-2”), the downlink reference signal time domain resources may include periodic DL reference signals with activation and deactivation.

In a third alternative (which may be referred to as “Alt B-1”), the downlink reference signal time domain resources may include intermittent DL reference signals. The intermittent DL reference signals may be implemented for the purpose of power saving and matching secret key refreshing rate. The indication of the intermittent DL reference signals may include ON duration and OFF duration with DL reference signal transmissions.

In a fourth alternative (which may be referred to as “Alt B-2”), the downlink reference signal time domain resources may include intermittent DL reference signal with activation and deactivation.

The configuration of physical layer key generation may include configuration of uplink reference signal. The configuration of uplink reference signal may include a type of uplink reference signal to be utilized for synchronization. In a first alternative, the type of uplink reference signal may be semi-persistent (SPS) (e.g., periodical SPS, semi-persistent SPS). In a second alternative, the type of uplink reference signal may be a new reference signal for measurements.

The configuration of physical layer key generation may include uplink reference signal time domain resources to be utilized for synchronization.

In a first alternative (which may be referred to as “Alt A-1”), the uplink reference signal time domain resources may include periodic UL reference signals. The indication of the uplink reference signal time domain reference signals may include slots with uplink (UL) reference signal (e.g., periodicity and offset), symbols with UL reference signal, and/or a starting time of periodic UL reference signal.

In a second alternative (which may be referred to as “Alt A-2”), the uplink reference signal time domain resources may include periodic UL reference signal with activation and deactivation.

In a third alternative (which may be referred to as “Alt B-1”), the uplink reference signal time domain resources may include intermittent UL reference signals. The intermittent UL references signals may be implemented for the purpose of power saving and matching secret key refreshing rate. The indication of the intermittent UL reference signals may include ON duration and OFF duration with UL reference signal transmissions.

In a fourth alternative (which may be referred to as “Alt B-2”), the uplink reference signal time domain resources may include intermittent UL reference signals with activation and deactivation.

The configuration of physical layer key generation may include linkage between UL reference signals and DL reference signals. The periodicity of UL reference signal may be equal to periodicity of DL reference signal. The ON duration and OFF duration for UL reference signal transmissions may equal to those for DL reference signal transmissions. Small offset may be possible between the UL ON duration and the DL ON duration. Time gap between the UL reference signal and the DL reference signal may be small enough, such as at least less than half of the channel coherence time.

The configuration of physical layer key generation may include error correction codes and/or error correction code information for the error correction codes. The error correction code information may include quantization information, such as the number of bits to be extracted from each channel estimation.

The error correction code information may include a type of error correction codes. In a first alternative, the type of error correction codes may be polar code. For the first alternative, the error correction codes can be the same or different from the channel codes used for control channel. In a second alternative, the type of error correction codes may be low-density parity-check (LDPC) code. For the second alternative, the error correction codes can be the same or different from the channel codes used for data channel. The configuration between polar code and LDPC code may depend on UE capability report.

The error correction code information may include block length, code rate, and/or rate matching schemes of error correction codes. Alternatively, the block length, code rate and rate matching schemes can be pre-defined. The block length of error correction codes may be used to determine the triggering of synchronization of physical layer key generation.

The configuration of physical layer key generation may include assistance information for physical layer key generation. The assistance information may include a transmitter of the assistance information (i.e., from the base station or from the UE), a number of quantization error bits, and/or a number of syndrome bits or cyclic redundancy check (CRC) bits.

The configuration of physical layer key generation may include a universal hashing function for key generation. The universal hashing function may include a ratio of universal hashing including the number of input bits and the number of output bits.

The configuration of physical layer key generation may include key verification information. The key verification information may include number and location of the key bits used for verification purpose.

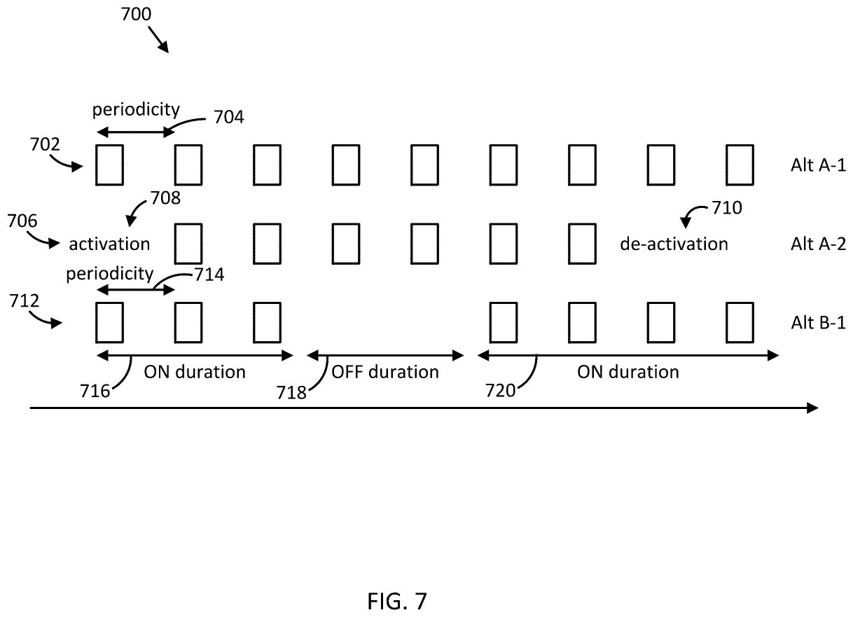

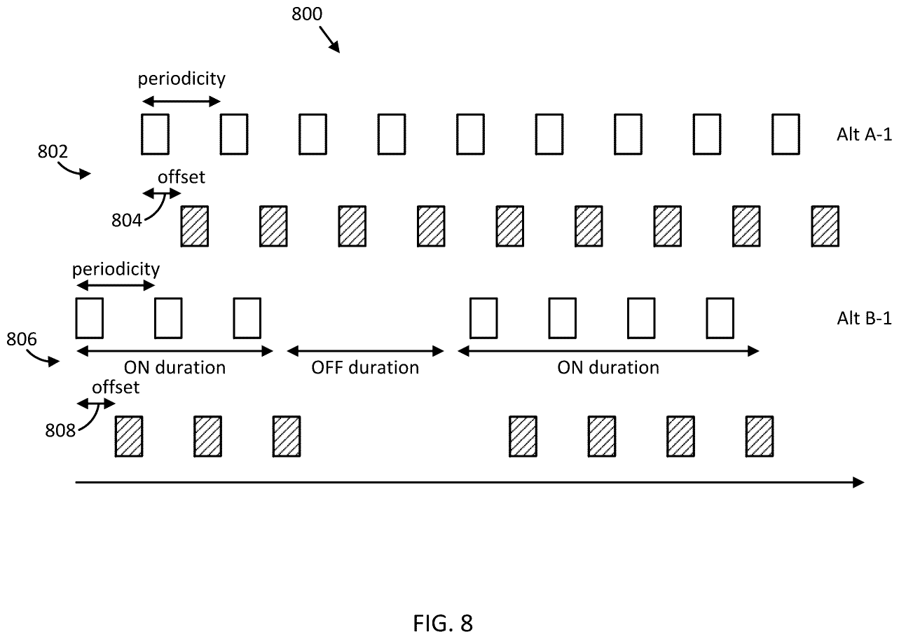

FIG. 7 illustrates example reference signal arrangements 700 in accordance with some embodiments. FIG. 8 illustrates additional example reference signal arrangements 800 in accordance with some embodiments. In particular, FIG. 7 and FIG. 8 illustrates downlink reference signal and uplink reference signal arrangements in accordance with embodiments. The rectangles without fill in FIG. 7 and FIG. 8 represent downlink reference signals. The rectangles with diagonal line fill in FIG. 7 and FIG. 8 represent uplink reference signals.

The reference signal arrangements 700 include a first reference signal arrangement 702. The first reference signal arrangement 702 illustrates an arrangement of downlink reference signals in accordance with the first alternative for configuring the downlink reference signal time domain resources. In particular, the first reference signal arrangement 702 illustrates downlink reference signal resources with a periodicity 704. The configuration of the downlink reference signal for the first reference signal arrangement 702 may indicate the periodicity 704, the slots for the DL reference signals, the symbols for the DL reference signals, and/or the starting time of the periodic reference signals.

The reference signal arrangements 700 include a second reference signal arrangement 706. The second reference signal arrangement 706 illustrates an arrangement of downlink reference signals in accordance with the second alternative for configuring the downlink reference signal time domain resources. In particular, the second reference signal arrangement 706 illustrates downlink reference signal resources transmitted based on an activation 708 and having transmission ceased based on a de-activation 710. The configuration of the downlink reference signal for the second reference signal arrangement 706 may indicate the periodicity for the DL reference signals, the slots for the DL reference signals, the symbols for the DL reference signals, and/or the starting time of the periodic reference signals.

The reference signal arrangements 700 include a third reference signal arrangement 712. The third reference signal arrangement 712 illustrates an arrangement of downlink reference signals in accordance with the third alternative for configuring the downlink reference signal time domain resources. In particular, the third reference signal arrangement 712 illustrates downlink reference signal resources with a periodicity 714 and ON/OFF durations. In particular, the third reference signal arrangement 712 includes ON duration 716, OFF duration 718, and ON duration 720. The downlink reference signals may be transmitted during the ON durations and not submitted during the OFF durations.

The reference signal arrangements 800 include a fourth reference signal arrangement 802. The fourth reference signal arrangement 802 illustrates an arrangement of downlink reference signals and uplink reference signals in accordance with the first alternative for configuring the uplink reference signal time domain resources. In particular, the fourth reference signal arrangement 802 illustrates uplink reference signal resources with a same periodicity as the downlink reference signal time domain resources. The uplink reference signal time domain resources may have an offset 804 from the downlink reference signal time domain resources. In some embodiments, the offset 804 may be at least less than half of the channel coherence time. The configuration of the uplink reference signal for the fourth reference signal arrangement 802 may indicate the periodicity for the UL reference signals, the slots for the UL reference signals, the symbols for the UL reference signals, and/or the starting time of the periodic reference signals.

The reference signal arrangements 800 include a fifth reference signal arrangement 806. The fifth reference signal arrangement 806 illustrates an arrangement of downlink reference signals and uplink reference signals in accordance with the third alternative for configuring the uplink reference signal time domain resources. In particular, the fifth reference signal arrangement 806 illustrates uplink reference signal resources with similar ON durations and OFF durations as the downlink reference signal resources. The uplink reference signal time domain resources may have an offset 808 from the downlink reference signal time domain resources. Further, the ON/OFF durations of the uplink reference signal time domain resources may have the offset 808 from the ON/OFF durations of the downlink reference signal time domain resources. In some embodiments, the offset 808 may be at least less than half of the channel coherence time.

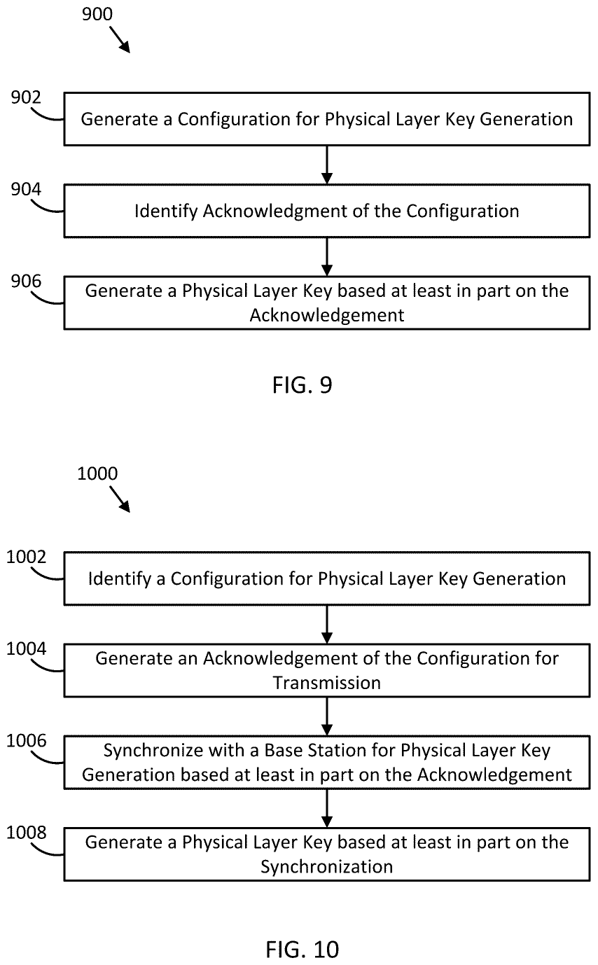

FIG. 9 illustrates an example procedure 900 for configuring physical layer key generation in accordance with some embodiments. The procedure 900 may be performed by a base station, such as the base station 108 (FIG. 1) and/or the network service 300 (FIG. 3).

The procedure 900 may include generating a configuration for physical layer key generation in 902, the configuration for transmission to a user equipment. In some embodiments, the configuration may include a downlink reference signal configuration or an uplink reference signal configuration.

In some embodiments, the configuration may indicate a type of downlink reference signal to be utilized for synchronization for the physical layer key generation. In some of these embodiments, the type of downlink reference signal may include a channel state information-reference signal (CSI-RS), a physical layer secret key specific reference signal, or a synchronization signal block (SSB).

In some embodiments, the configuration may indicate downlink reference signal time domain resources for synchronization for the physical layer key generation. In some of these embodiments, the downlink reference signal time domain resources may include periodic downlink reference signals, periodic DL reference signals with activation and deactivation, intermittent downlink reference signals, or intermittent downlink reference signals with activation and deactivation.

In some embodiments, the configuration may indicate a type of uplink reference signal to be utilized for synchronization for the physical layer key generation. In some embodiments, the configuration may indicate that periodic uplink reference signals, periodic uplink reference signals with activation and deactivation, intermittent uplink reference signals, or intermittent uplink reference signals with activation and deactivation are to be utilized for as uplink reference signal time domain resources for synchronization for the physical layer key generation.

In some embodiments, the configuration may include error correction code information. In some of these embodiments, the error correction code information may include quantization information, a type of error correction code information, or block length, code rate, and rate matching schemes of error correction codes information.

The procedure 900 may include identifying acknowledgement of the configuration in 904.

The procedure 900 may include generating a physical layer key based at least in part on the acknowledgement in 906.

Any one or more of the operations in FIG. 9 may be performed in a different order than shown and/or one or more of the operations may be performed concurrently in embodiments. Further, it should be understood that one or more of the operations may be omitted from and/or one or more additional operations may be added to the procedure 900 in other embodiments.

FIG. 10 illustrates an example procedure 1000 for synchronizing for generating a physical layer key in accordance with some embodiments. The procedure 1000 may be performed by a UE, such as the UE 104 (FIG. 1), the UE 106 (FIG. 1), and/or the UE 200 (FIG. 2).

The procedure 1000 may include identifying a configuration for physical layer key generation in 1002.

The procedure 1000 may include generating an acknowledgement of the configuration for transmission in 1004.

The procedure 1000 may include synchronizing with a base station for the physical layer key generation based at least in part on the acknowledgement of the configuration in 1006.

In some embodiments, the acknowledgement may include a modified configuration. The synchronizing with the base station may be based at least in part on the modified configuration.

In some embodiments, the configuration may indicate a type of uplink reference signals to be utilized for synchronization with the base station. The synchronizing with the base station may be performed using the type of the uplink reference signals.

In some embodiments, the configuration may indicate error correction code information. The synchronizing with the base station may be performed in accordance with the error correction code information.

In some embodiments, synchronizing with the base station may include generating a synchronization message for transmission to the base station. The synchronization message may include an indication whether a corresponding downlink reference signal measurement or a corresponding uplink reference signal measurement is successful or reliable.

The procedure 1000 may include generating a physical layer key based at least in part on the synchronization in 1008.

Any one or more of the operations in FIG. 10 may be performed in a different order than shown and/or one or more of the operations may be performed concurrently in embodiments. Further, it should be understood that one or more of the operations may be omitted from and/or one or more additional operations may be added to the procedure 1000 in other embodiments.

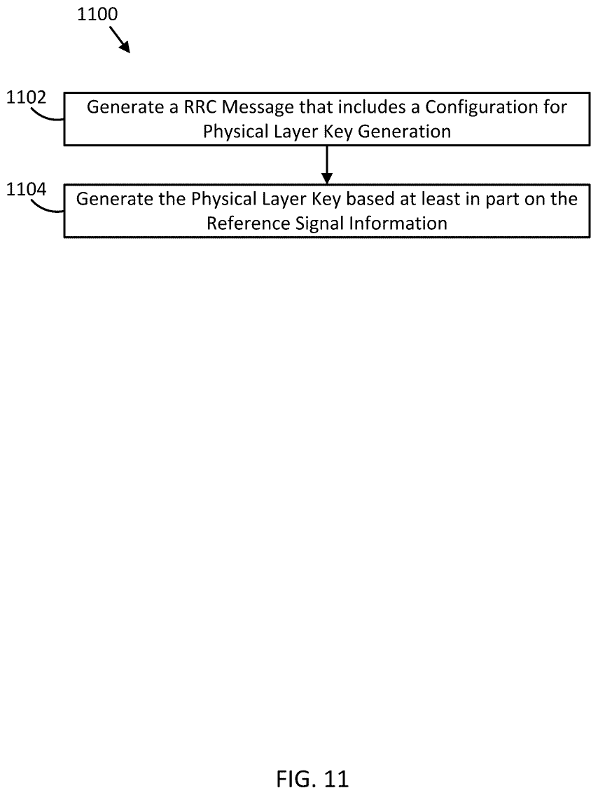

FIG. 11 illustrates an example procedure 1100 for generating a physical layer key in accordance with some embodiments. The procedure 1100 may be performed by a base station, such as the base station 108 (FIG. 1) and/or the network device 300 (FIG. 3).

The procedure 1100 may include generating a radio resource control (RRC) message that includes a configuration for physical layer key generation in 1102. The configuration may indicate reference signal information for synchronization for generation of a physical layer key.

In some embodiments, the reference signal information may indicate a type of downlink reference signal and downlink reference signal time domain resources to be utilized for synchronization for generation of the physical layer key. Further, the reference signal information may indicate a type of uplink reference signal and uplink reference signal time domain resources to be utilized for synchronization for generation of the physical layer key.

In some embodiments, the procedure 1100 may include identifying an acknowledgement message, received from a user equipment (UE), corresponding to the RRC message. The acknowledgement message may include a modified configuration for generation of the physical layer key. Further, the procedure 1100 may include synchronizing with the UE based at least in part on the modified configuration.

The procedure 1100 may include generating the physical layer key based at least in part on the reference signal information.

Any one or more of the operations in FIG. 11 may be performed in a different order than shown and/or one or more of the operations may be performed concurrently in embodiments. Further, it should be understood that one or more of the operations may be omitted from and/or one or more additional operations may be added to the procedure 1100 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising generating a configuration for physical layer key generation, the configuration for transmission to a user equipment, identifying acknowledgement of the configuration, and generating a physical layer key based at least in part on the acknowledgement.

Example 2 may include the method of example 1, wherein the configuration includes a downlink reference signal configuration or an uplink reference signal configuration.

Example 3 may include the method of example 1, wherein the configuration indicates a type of downlink reference signal to be utilized for synchronization for the physical layer key generation.

Example 4 may include the method of example 3, wherein the type of downlink reference signal includes a channel state information-reference signal (CSI-RS), a physical layer secret key specific reference signal, or a synchronization signal block (SSB).

Example 5 may include the method of example 1, wherein the configuration indicates downlink reference signal time domain resources for synchronization for the physical layer key generation.

Example 6 may include the method of example 5, wherein the downlink reference signal time domain resources include periodic downlink reference signals, periodic DL reference signals with activation and deactivation, intermittent downlink reference signals, or intermittent downlink reference signals with activation and deactivation.

Example 7 may include the method of example 1, wherein the configuration indicates a type of uplink reference signal to be utilized for synchronization for the physical layer key generation.

Example 8 may include the method of example 1, wherein the configuration indicates that periodic uplink reference signals, periodic uplink reference signals with activation and deactivation, intermittent uplink reference signals, or intermittent uplink reference signals with activation and deactivation are to be utilized for as uplink reference signal time domain resources for synchronization for the physical layer key generation.

Example 9 may include the method of example 1, wherein the configuration includes error correction code information.

Example 10 may include the method of example 9, wherein the error correction code information includes quantization information, a type of error correction code information, or block length, code rate, and rate matching schemes of error correction codes information.

Example 11 may include the method of example 1, further comprising generating a synchronization for physical layer key generation information message for transmission.

Example 12 may include the method of example 11, wherein the synchronization for physical layer key generation information message includes a bitmap that indicates whether a corresponding reference signal measurement is successful or reliable.

Example 13 may include the method of example 11, wherein the synchronization for physical layer key generation information message is to be transmitted via medium access control (MAC) control element (CE) or radio resource control (RRC).

Example 14 may include the method of example 1, further comprising generating an assistant information for physical layer key generation message for transmission.

Example 15 may include the method of example 14, wherein the assistant information for physical layer key generation message includes cyclic redundancy check (CRC) bits of polar codes or syndrome bit of low-density parity-check (LDCP) codes, or quantization error bits.

Example 16 may include the method of example 14, wherein the assistant information for physical layer key generation message is to be transmitted via medium access control (MAC) control element (CE) or radio resource control (RRC).

Example 17 may include the method of example 1, further comprising generating an alignment of physical layer key message for transmission.

Example 18 may include the method of example 17, wherein the alignment of physical layer key message includes a bit sequence derived from the physical layer key.

Example 19 may include the method of example 17, wherein the alignment of physical layer key message is to be transmitted via medium access control (MAC) control element (CE) or radio resource control (RRC).

Example 20 may include a method comprising identifying a configuration for physical layer key generation, generating an acknowledgement of the configuration for transmission, synchronizing with a base station for the physical layer key generation based at least in part on the acknowledgement of the configuration, and generating a physical layer key based at least in part on the synchronization.

Example 21 may include the method of example 20, wherein the acknowledgement includes a modified configuration, and wherein the synchronizing with the base station is based at least in part on the modified configuration.

Example 22 may include the method of example 20, wherein the configuration indicates a type of downlink reference signals to be utilized for synchronization with the base station, wherein the synchronizing with the base station is performed using the type of the downlink reference signals.

Example 23 may include the method of example 20, wherein the configuration indicates a type of uplink reference signals to be utilized for synchronization with the base station, wherein the synchronizing with the base station is performed using the type of the uplink reference signals.

Example 24 may include the method of example 20, wherein the configuration indicates error correction code information, wherein the synchronizing with the base station is performed in accordance with the error correction code information.

Example 25 may include the method of example 20, wherein synchronizing with the base station includes generating a synchronization message for transmission to the base station, the synchronization message includes an indication whether a corresponding downlink reference signal measurement or a corresponding uplink reference signal measurement is successful or reliable.

Example 26 may include the method of example 20, further comprising generating an assistant information for physical layer key generation message for transmission.

Example 27 may include the method of example 26, wherein the assistant information for physical layer key generation message includes cyclic redundancy check (CRC) bits of polar codes or syndrome bit of low-density parity-check (LDCP) codes, or quantization error bits.

Example 28 may include the method of example 26, wherein the assistant information for physical layer key generation message is to be transmitted via medium access control (MAC) control element (CE) or radio resource control (RRC).

Example 29 may include the method of example 20, further comprising generating an alignment of physical layer key message for transmission.

Example 30 may include the method of example 29, wherein the alignment of physical layer key message includes a bit sequence derived from the physical layer key.

Example 31 may include the method of example 29, wherein the alignment of physical layer key message is to be transmitted via medium access control (MAC) control element (CE) or radio resource control (RRC).

Example 32 may include a method comprising generating a radio resource control (RRC) message that includes a configuration for physical layer key generation, the configuration indicating reference signal information for synchronization for generation of a physical layer key, and generating the physical layer key based at least in part on the reference signal information.

Example 33 may include the method of example 32, wherein the reference signal information indicates a type of downlink reference signal and downlink reference signal time domain resources to be utilized for synchronization for generation of the physical layer key.

Example 34 may include the method of example 32, wherein the reference signal information indicates a type of uplink reference signal and uplink reference signal time domain resources to be utilized for synchronization for generation of the physical layer key.

Example 35 may include the method of example 32, further comprising identifying an acknowledgement message, received from a user equipment (UE), corresponding to the RRC message, wherein the acknowledgement message includes a modified configuration for generation of the physical layer key, and synchronizing with the UE based at least in part on the modified configuration.

Example 36 may include an apparatus comprising means to perform one or more elements of a method described in or related to any of examples 1-35, or any other method or process described herein.

Example 37 may include one or more non-transitory computer-readable media comprising instructions to cause an electronic device, upon execution of the instructions by one or more processors of the electronic device, to perform one or more elements of a method described in or related to any of examples 1-35, or any other method or process described herein.

Example 38 may include an apparatus comprising logic, modules, or circuitry to perform one or more elements of a method described in or related to any of examples 1-35, or any other method or process described herein.

Example 39 may include a method, technique, or process as described in or related to any of examples 1-35, or portions or parts thereof.

Example 40 may include an apparatus comprising: one or more processors and one or more computer-readable media comprising instructions that, when executed by the one or more processors, cause the one or more processors to perform the method, techniques, or process as described in or related to any of examples 1-35, or portions thereof.

Example 41 may include a signal as described in or related to any of examples 1-35, or portions or parts thereof.

Example 42 may include a datagram, information element, packet, frame, segment, PDU, or message as described in or related to any of examples 1-35, or portions or parts thereof, or otherwise described in the present disclosure.

Example 43 may include a signal encoded with data as described in or related to any of examples 1-35, or portions or parts thereof, or otherwise described in the present disclosure.

Example 44 may include a signal encoded with a datagram, IE, packet, frame, segment, PDU, or message as described in or related to any of examples 1-35, or portions or parts thereof, or otherwise described in the present disclosure.

Example 45 may include an electromagnetic signal carrying computer-readable instructions, wherein execution of the computer-readable instructions by one or more processors is to cause the one or more processors to perform the method, techniques, or process as described in or related to any of examples 1-35, or portions thereof.

Example 46 may include a computer program comprising instructions, wherein execution of the program by a processing element is to cause the processing element to carry out the method, techniques, or process as described in or related to any of examples 1-35, or portions thereof.

Example 47 may include a signal in a wireless network as shown and described herein.

Example 48 may include a method of communicating in a wireless network as shown and described herein.

Example 49 may include a system for providing wireless communication as shown and described herein.

Example 50 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
generating a configuration for physical layer key generation, the configuration for transmission to a user equipment;
identifying acknowledgement of the configuration; and
generating a physical layer key based at least in part on the acknowledgement.

2. The method of claim 1, wherein the configuration includes a downlink reference signal configuration or an uplink reference signal configuration.

3. The method of claim 1, wherein the configuration indicates a type of downlink reference signal to be utilized for synchronization for the physical layer key generation.

4. The method of claim 3, wherein the type of downlink reference signal includes a channel state information-reference signal (CSI-RS), a physical layer secret key specific reference signal, or a synchronization signal block (SSB).

5. The method of claim 1, wherein the configuration indicates downlink reference signal time domain resources for synchronization for the physical layer key generation.

6. The method of claim 5, wherein the downlink reference signal time domain resources include periodic downlink reference signals, periodic DL reference signals with activation and deactivation, intermittent downlink reference signals, or intermittent downlink reference signals with activation and deactivation.

7. The method of claim 1, wherein the configuration indicates a type of uplink reference signal to be utilized for synchronization for the physical layer key generation.

8. The method of claim 1, wherein the configuration indicates periodic uplink reference signals, periodic uplink reference signals with activation and deactivation, intermittent uplink reference signals, intermittent uplink reference signals with activation and deactivation, or linkage information between uplink reference signals and downlink reference signals to be utilized for as uplink reference signal time domain resources for synchronization for the physical layer key generation.

9. The method of claim 1, wherein the configuration includes error correction code information, assistance information for physical layer key generation, universal hashing function information for key generation, or key verification information.

10. The method of claim 9, wherein the error correction code information includes:
quantization information;
a type of error correction code information; or
block length, code rate, and rate matching schemes of error correction codes information.

11. One or more non-transitory computer-readable media having instructions that, when executed, cause processing circuitry to:
identify a configuration for physical layer key generation;
generate an acknowledgement of the configuration for transmission;
synchronize with a base station for the physical layer key generation based at least in part on the acknowledgement of the configuration; and
generate a physical layer key based at least in part on the synchronization.

12. The one or more non-transitory computer-readable media of claim 11, wherein the acknowledgement includes a modified configuration, and wherein the synchronize with the base station is based at least in part on the modified configuration.

13. The one or more non-transitory computer-readable media of claim 11, wherein the configuration indicates a type of downlink reference signals to be utilized for synchronization with the base station, wherein the synchronize with the base station is performed using the type of the downlink reference signals.

14. The one or more non-transitory computer-readable media of claim 11, wherein the configuration indicates a type of uplink reference signals to be utilized for synchronization with the base station, wherein the synchronize with the base station is performed using the type of the uplink reference signals.

15. The one or more non-transitory computer-readable media of claim 11, wherein the configuration indicates error correction code information, wherein the synchronize with the base station is performed in accordance with the error correction code information.

16. The one or more non-transitory computer-readable media of claim 11, wherein to synchronize with the base station includes to generate a synchronization message for transmission to the base station, wherein the synchronization message includes an indication whether a corresponding downlink reference signal measurement or a corresponding uplink reference signal measurement is successful or reliable.

17. An apparatus comprising:
processing circuitry to:
generate a radio resource control (RRC) message that includes a configuration for physical layer key generation, the configuration indicating reference signal information for synchronization for generation of a physical layer key; and
generate the physical layer key based at least in part on the reference signal information; and
interface circuitry coupled with the processing circuitry, the interface circuitry to enable communication.

18. The apparatus of claim 17, wherein the reference signal information indicates a type of downlink reference signal and downlink reference signal time domain resources to be utilized for synchronization for generation of the physical layer key.

19. The apparatus of claim 17, wherein the reference signal information indicates a type of uplink reference signal and uplink reference signal time domain resources to be utilized for synchronization for generation of the physical layer key.

20. The apparatus of claim 17, wherein the processing circuitry is further to:
identify an acknowledgement message, received from a user equipment (UE), corresponding to the RRC message, wherein the acknowledgement message includes a modified configuration for generation of the physical layer key; and
synchronize with the UE based at least in part on the modified configuration.
